(19) United States
(12) Patent Application Publication
(10) Pub. No.: US 2013/0185772 A1
(43) Pub. Date: Jul. 18, 2013

(54) DYNAMICALLY UPDATING A SESSION BASED ON LOCATION DATA FROM AN AUTHENTICATION DEVICE

(71) Applicant: Aventura HQ, Inc., Denver, CO (US)

(72) Inventors: Joe Jaudon, Sedalia, CO (US); David Lowrey, Denver, CO (US); Adam Williams, Aurora, CO (US)

(73) Assignee: Aventura HQ, Inc., Denver, CO (US)

(21) Appl. No.: 13/739,612

(22) Filed: Jan. 11, 2013

Related U.S. Application Data
(60) Provisional application No. 61/585,960, filed on Jan. 12, 2012.

(51) Int. Cl. H04L 29/06

(52) U.S. Cl. CPC H04L 63/08
USPC 726/4

(57) ABSTRACT

Systems, devices, methods, and software are described for dynamically updating a session based on location data from an access device, such as an access card reader. In one example, a method of managing at least one centrally hosted virtual session may include: associating a user with a virtual session, a first terminal device, and a first location at a central server computer system; receiving a notification at the central server computer system that an access token associated with the user has been received at an access device associated with a second terminal device and a second location; associating the virtual session with the second location in response to the notification; and updating the virtual session at the first terminal device according to at least one location-based rule associated with the second location.

### CROSS REFERENCES

The present application claims priority from U.S. Provisional Patent Application Ser. No. 61/585,960, entitled “DYNAMICALLY UPDATING A SESSION BASED ON LOCATION DATA FROM AN AUTHENTICATION DEVICE” and filed on Jan. 12, 2012, which is incorporated herein by reference in its entirety for all purposes.

### BACKGROUND

The present invention relates to computer network communication, and more particularly, to updating resource access permissions in a virtual computing environment.

Various computer systems may use a thin-client or a virtual desktop display in conjunction with a centralized server computer system or mainframe. Virtualization is a logical representation of a computer in software. By decoupling the physical hardware from aspects of operation, virtualization may provide more operational flexibility and increase the utilization rate of the underlying physical hardware. Although virtualization is implemented primarily in software, many modern microprocessors now include hardware features explicitly designed to improve the efficiency of the virtualization process.

A virtual session can be served to client devices from a central or distributed server computer system. The server may receive input and output over a network or other communication medium established between the device and the server. In some examples, a thin-client device may run web browsers or remote desktop software, such that significant processing may occur on the server.

In many instances, roaming users may be delayed as they transition to new applications when they move to new locations. This wait time can negatively impact productivity and efficiency. Thus, there may be a need in the art to reduce wait periods as users roam and transition in and out of different workflows.

### SUMMARY

Methods, systems, and devices are described for dynamically updating sessions based on location data from authentication devices.

In one set of illustrative embodiments, a method of managing at least one centrally hosted virtual session includes associating a user with a virtual session, a first terminal device, and a first location at a central server computer system; receiving a notification at the central server computer system that an access token associated with the user has been received at an access device associated with a second terminal device and a second location; associating the virtual session with the second location in response to the notification; and updating the virtual session at the first terminal device according to at least one location-based rule associated with the second location.

In a second set of illustrative embodiments, a central server computer system for managing at least one virtual session may include at least: a session association module configured to associate a user with a virtual session, a first terminal device, and a first location at a central server computer system; an access token event receiving module configured to receive a notification that an access token associated with the user has been received at an access device associated with a second terminal device and a second location, wherein the session association module is further configured to associate the virtual session with the second location in response to the notification; and a session updating module configured to update the virtual session at the first terminal device according to at least one location-based rule associated with the second location.

In a third set of illustrative embodiments, a computer program product may include a tangible computer readable device comprising computer-readable instructions stored thereon. The computer-readable instructions may be configured to cause at least one processor, upon execution of the computer-readable instructions, to: associate a user with a virtual session, a first terminal device, and a first location at a central server computer system; receive a notification that an access token associated with the user has been received at an access device associated with a second terminal device and a second location; associate the virtual session with the second location in response to the notification; and update the virtual session at the first terminal device according to at least one location-based rule associated with the second location.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a block diagram of an example system including components configured according to various embodiments of the invention.

FIGS. 3A, 3B, 3C, and 3D are block diagrams of an example system at different points of time, the system including components configured according to various embodiments of the invention.

FIG. 4 is a block diagram of an example system including components configured according to various embodiments of the invention.

FIG. 5 is a block diagram of an example system including components configured according to various embodiments of the invention.

FIGS. 6A, 6B, and 6C are diagrams of example tables of session information according to various embodiments of the invention.

FIG. 7 is a flowchart diagram of an example method of managing a centrally hosted virtual session according to various embodiments of the invention.

FIG. 8 is a flowchart diagram of an example method of managing a centrally hosted virtual session according to various embodiments of the invention.

FIG. 9 is a flowchart diagram of an example method of managing a centrally hosted virtual session according to various embodiments of the invention.

FIG. 10 is a schematic diagram that illustrates a representative device structure that may be used in various embodiments of the present invention.

### DETAILED DESCRIPTION OF THE INVENTION

Systems, devices, methods, and software are described for managing a centrally hosted virtual session based on location data from an authentication device. A central server computer system may interact with a user through a virtual session. The session may be associated with the user, a location and a device. The user may receive location-specific information from the central server computer system on the device associated with the virtual session according to the location associated with the session. An access token event associated with the receipt of an access token from the user at an access device having a known location may be used to update the virtual session. For example, the user may tap an access card at an access card reader having a known location to update the location associated with the user's virtual session to the known location of the authentication device. If the user authenticates twice at the same authentication device within a predetermined amount of time, the user's virtual session may be transferred to a terminal device associated with the authentication device.

This description provides examples and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used herein, the term “virtual session” or “session” refers to a hosted session of a virtual computing environment associated with a particular user that may be accessed from one or more client devices other than the host. For example, a session may include a thin client session, a virtual application session, a virtual machine session, a virtual operating system session, and/or the like. As used herein, a session described as being “between” a host device and a terminal device refers to the exchange of data between the host device and the terminal device, where the data is related to the session hosted at the host device.

As used herein, the term “terminal device” refers to a device configured to provide a user interface for a remotely hosted virtual session to a user associated with the virtual session.

For the purpose of clarity in description, the following description describes systems, devices, methods, and software for dynamically updating a session based on data received from an access card reader. However, it should be understood that the same principles may be applied to the receipt of authentication data from any type of peripheral or standalone access or authentication device, including access card readers, smart card readers, biometric data readers, keypads, buttons, near field communications (NFC) devices, and the like.

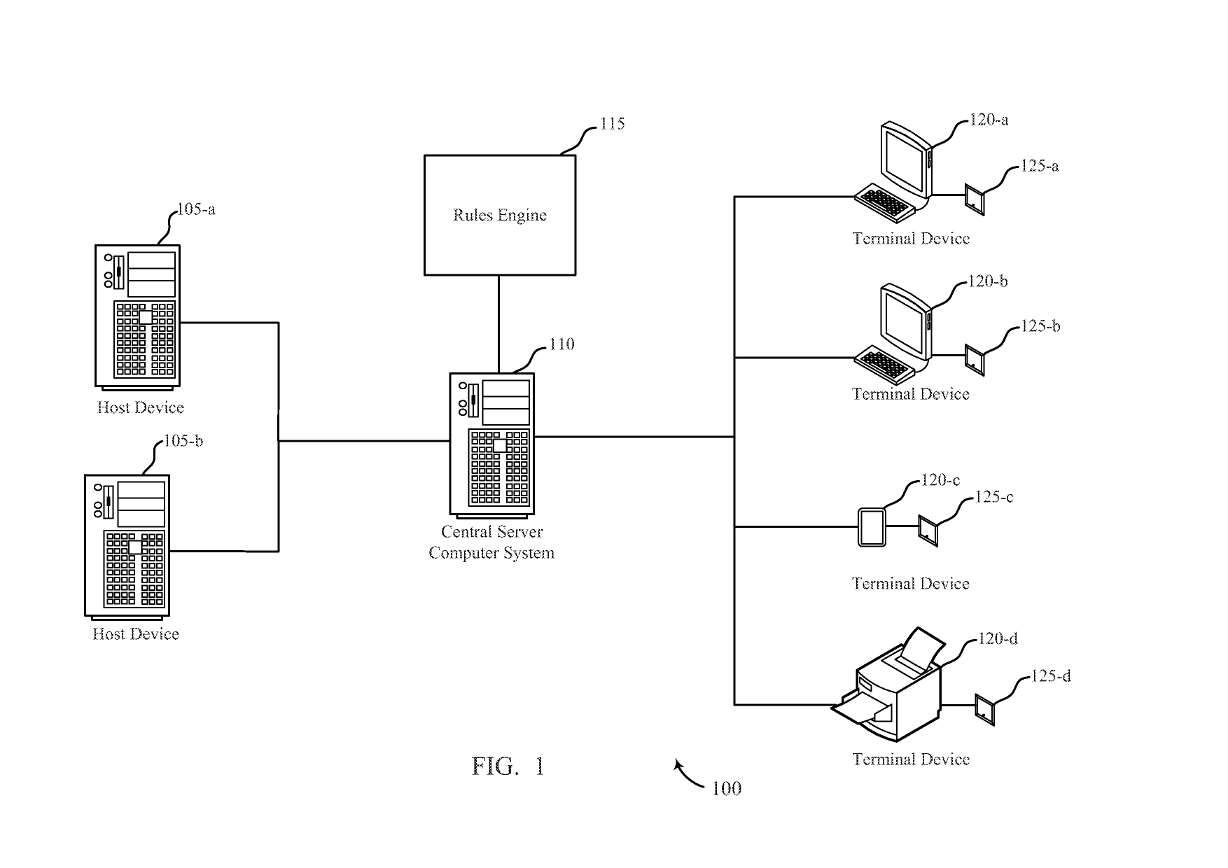

FIG. 1 illustrates an example system 100 including host devices 105, a central server computer system 110, a rules engine 115, terminal devices 120 (e.g., workstation 120-a, workstation 120-b, smartphone 120-c, and printer 120-d), and access devices 125 (e.g., proximity card readers 125). Each of these components may be in communication, directly or indirectly.

The components of the system 100 may be directly connected, or may be connected via a network, which may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. The network may include both wired and wireless connections, including optical links. Many other examples are possible and apparent to those skilled in the art in light of this disclosure. In the discussion herein, a network may or may not be noted specifically. If no specific means of connection is noted, it may be assumed that the link, communication, or other connection between devices may be via a network.

In the system 100 of FIG. 1, the central server computer system 110 may be communicatively coupled with a number of host devices 105 and terminal devices 120. The central server computer system 110 may be configured to forward network packets between the host devices 105 and the terminal devices 120. The central server computer system 110 may be implemented by a single server device or by a number of related components interconnected over a network. A single host device 105 may include one or more servers. Each of the host devices 105 may be configured to provide one or more services. These services may vary in scope and function.

In one example, a number of host devices 105 may host virtual sessions on behalf of users of the terminal devices 120. Each virtual session hosted at a host device 105 may be associated with a particular user. A user may access a session hosted by a host device 105 through one of the terminal devices 120. A terminal device 120 may function as a thin client, and the host device 105-a may provide operating system functionality remotely to the terminal device 120 while the terminal device 120 provides keyboard, video, and mouse (KVM) functionality for the session to the user. Alternatively, the terminal device 120 may execute the operating system based on settings provided for the user from the host device 105.

Each of the access devices 125 may be configured to receive access tokens from users. In the present example, the access devices 125 are proximity card readers. Alternatively, one or more of the access devices 125 may include biometric readers, keypads, magnetic card readers, wireless transceivers for communicating with mobile devices, or other types of access devices. When a user provides an access token to an access device 125, rather than processing the received access token only in the operating system of the terminal device 120 associated with the access device 125, the terminal device 120 may generate an access token event and transmit the access token event to the central server computer system 110. The central server computer system 110 may apply a set of rules from the rules engine 115 to the access token event to determine one or more appropriate actions to take based on the access token event. The central server computer system 110 may then take the appropriate action or instruct a terminal device 120 or host device 105 to take the appropriate action.

In certain examples, the central server computer system 110 may store a set of rules locally and implement all of the functionality of the rules engine 115. In alternative examples, the rules engine 115 may be at least partially implemented as a logically or physically separate entity from the central server computer system 110. The rules implemented by the rules engine 115 may include rules for allocating virtual sessions, monitoring virtual sessions, and updating virtual sessions based on location and other factors. The rules engine 115 may include a single database of rules, or may include any number of separate and distinct rules databases. The rules engine 115 may include one, or more, relational databases or components of relational databases (e.g., tables), object databases, or components of object databases, spreadsheets, text files, internal software lists, or any other type of data structure suitable for storing data.

In some examples, a central server computer system 110 monitors virtual sessions (e.g., via direct monitoring or via reports from terminal devices 120). To initiate a session, a user may log on to a terminal device 120-a-1 by presenting authentication credentials (e.g., a user name, password, key card, key fob, and/or biometric sign-in, etc.), and the terminal device 120-a-1 may transmit the authentication credentials or other information to the central server computer system 110. The central server computer system 110 may direct a session to be started for the user. In certain examples, the central server computer system 110 may begin to initiate the virtual session before authentication of the user has occurred or is completed. One or more default aspects and/or settings may be applied to the session, and the user may be granted certain access permissions for the session (e.g., access permissions to drives, directories, folders, files, applications, etc.). Certain of these default aspects, settings, and access permissions may be based on the location of the terminal device 120-a-1 (e.g., and also be based on user type, client device type, session type, etc.).

There may be location-specific rules for updating one or more aspects, settings, and/or access permissions of the virtual session, applicable to individual users, types of users, sessions, types of sessions, applications, specific client devices, types of devices, etc. The location-specific rules may apply to a particular client device, all client devices in an area, or certain types of client devices in an area. The aspects and settings of the virtual session may, for example, relate to an appearance or display status of a user interface for the virtual session, the status of one or more applications (e.g., executed/running vs. unexecuted/closed) within or associated with the virtual session, the value of one or more session variables, the status (e.g., open, closed) one or more files in the virtual session, the association of one or more printers or other default peripheral devices with the session, and/or the like. The access permission rules may relate to controlling, restricting, manipulating, or restricting resources. Resources may include applications, computing resources, network resources, or system resources.

The location-based rules may be associated with one or more actions. In certain examples, the action may be to allow or block access to a resource, such as, for instance, a folder in a network drive, an application, and/or a network, based on location. In additional or alternative examples, the action may be to create, open, close, or delete an application, a file, a user profile, a setting, or the like. In still other additional or alternative examples, the action may be to open or hide a certain aspect of the session. For instance, an application associated with the session may continue to run in the background, but the access permission rule may hide the application from the user, thereby preventing the user from viewing or access the running application through the session. Additionally or alternatively, the action may affect some other aspect of the user interface of the session, such as minimizing or maximizing a certain application, file, or folder; reordering the display of graphical elements in the session; moving graphical elements in the session; drawing certain graphical elements in the session; painting certain graphical elements in the session; filling certain graphical elements in the session; clearing certain graphical elements in the session; and/or coloring certain graphical elements in the session.

In additional or alternative examples, the action initiated according to the one or more location-based rules may include displaying certain text or graphics to the user, prompting the user to provide textual or other input to the session, and/or initiating communications via input/output (I/O) devices or ports. In still other additional or alternative examples, the action may include modifying a session variable based on the second location, associating or disassociating one or more printers or other peripheral devices with the session based on the second location, and/or modifying a security setting associated with the session based on the second location.

When the virtual session associated with a user changes its association from a first location to a second location, the central server computer system 110 may identify any location-specific rules applicable to the change in location and initiate actions according to the rules. Thus, the central server computer system 110 may follow individual virtual sessions, and detect when a location-based rule is triggered by monitoring user movement. The central server computer system 110 may call up the resultant action, and either modify the session or transmit modification information accordingly prior to authenticating the user for access to the session at the new location. Using this technique, sessions can be adapted dynamically based on location while minimizing delays perceived by the user when accessing the session for the first time after changing locations.

The user of a virtual session may change the location associated with the virtual session using an access device 125 associated with a terminal device 120 at the new location. In certain examples, the user may provide an access token to the identified access device 125 at the associated terminal device 120 without disturbing a separate virtual session of another user who is already logged on to and using the associated terminal device 120. The provision of the access token at the new location may be detected and processed by the central server computer system 110 to dynamically update the location associated with the virtual session of the user and apply any location based rules arising out of the change in location. In certain examples, the location-based rules may be applied to the virtual session before the user is permitted to access the virtual session at the new location.

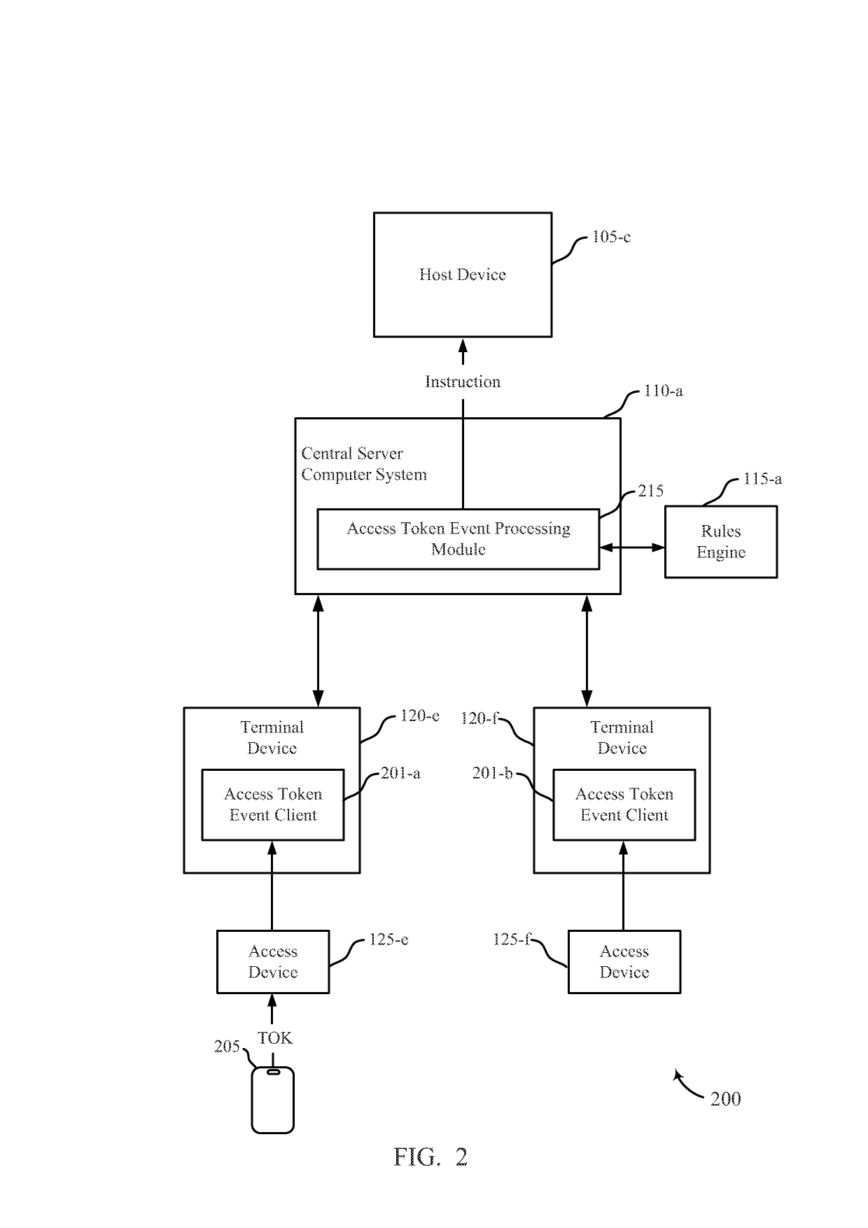

FIG. 2 is a block diagram of another example system 200 according to the principles described herein. The system 200 of the present example includes a central server computer system 110-a communicatively coupled with a number of terminal devices 120 and a rules engine 115-a. The central server computer system 110-a may be further coupled with a number one or more host devices 105-c configured to execute virtual sessions on behalf of the users of the terminal devices 120. The system 200 may be an example of the system 100 described above with reference to FIG. 1.

In the present example, a first terminal device 120-e may be communicatively coupled with an access device 125-e configured to receive access tokens from users. The access device 125-e may be a peripheral device of the terminal device 120-e. The terminal device 120-e may be configured to locally execute an access token event client 201-a to manage the access device 125-e and listen for new access tokens. When the access device 125-e receives an access token from a user, the access token event client 201-a may detect the access token and generate an access token event. Instead of processing the received access token only at the terminal device 120-e, the access token event client 201-a may transmit the generated access token event to the central server computer system 110-a.

The central server computer system 110-a may implement an access token event receiving module 215 that receives access token events from the terminal devices 120, consults the rules engine 115-a to identify one or more appropriate actions based on the received access token event, and causes the actions to be executed at the host devices 105, the terminal devices 120, or the central server computer system 110. Functional components of the rules engine 115-a may be implemented within the central server computer system 110-a or separate from the central server computer system 110-a.

In the present example, the central server computer system 110-a may manage a number of virtual sessions associated with the terminal devices 120. A user may initiate a virtual session at terminal device 120-e by providing an access token (TOK) to an access device 125-e. For example, the access device 125-e may be an access card reader and the user may provide the access token with a physical access card 205. In alternative examples, other types of physical or non-physical methods of providing access tokens to the access device 125-e may be used. The receipt of the access token at the access device 125-e may cause the access token event client 201-a of the terminal device 120-e to generate an access token event, which may be received and processed by the access token event receiving module 215 of the central server computer system 110-a prompt the user to enter additional credentials (e.g., a password), generate the virtual session at host device 105-c, and associate the virtual session with the user and a location. The virtual session may be initially associated with a location based on input from the user, a known location of the terminal device 120 at which the user credentials are received, and/or a default location. With the terminal device 120, the user may be able to access location-specific and general information from the host device 105-c or the central server computer system 110-a through the virtual session.

The user may update the location associated with his or her virtual session to a second location by providing his or her access token to access device 125-f at the second location at the central server computer system 110-a. For example, a user accessing a virtual session at the central server computer system 110-a through a portable tablet terminal device 120-e may tap an access card to an access card reader device coupled with a workstation terminal device 120-f at the second location. The workstation terminal device 120-f may detect the received access token at the access device 125-f and relay an access token event indicating the tap over the network to the central server computer system 110-a, which may update the location associated with the user's session to the known location of the access card reader 125-f and workstation terminal device 120-f. In response to the updated location information associated with the virtual session, one or more location-based rules at the rules engine 115-a may be triggered to update certain aspects of the virtual session delivered to the portable tablet terminal device 120-e.

Continuing the example, the user may choose to transfer his or her virtual session over to the workstation terminal device 120-f associated with the access card reader 125-f in the second location. For instance, the user may do this to invoke a feature or capability at the workstation terminal device 120-f that is not available at the portable tablet terminal device 120-e. To perform the transfer of the virtual session from the portable tablet terminal device 120-e to the workstation terminal device 120-f, the user may tap the access card at the access device 125-f a second time within a predetermined period from the first tap of the access card.

An access token event indicative of this second tap may be relayed by the workstation terminal device 120-f to the central server computer system 110-a, which may then automatically associate the selected workstation terminal device 120-f with the virtual session of the user. For example, a screen and controls appearing on the portable tablet terminal device 120-e may appear on the workstation terminal device 120-f. In certain examples, certain aspects of the user interface of the virtual session may change when the virtual session is moved over to the workstation terminal device 120-f. For example, additional features or controls may be provided in connection with the virtual session at the workstation terminal device 120-f that were not available at the table terminal device 120-e.

As described above, other tapping sequences may be used. In certain examples, the user may transfer his or her virtual session over to the workstation terminal device 120-f associated with the second location with the first tap of the access card at access device 125-f, and the location of the session may be updated to the location of the access device 125-f only if the access card is tapped twice within a predetermined amount of time.

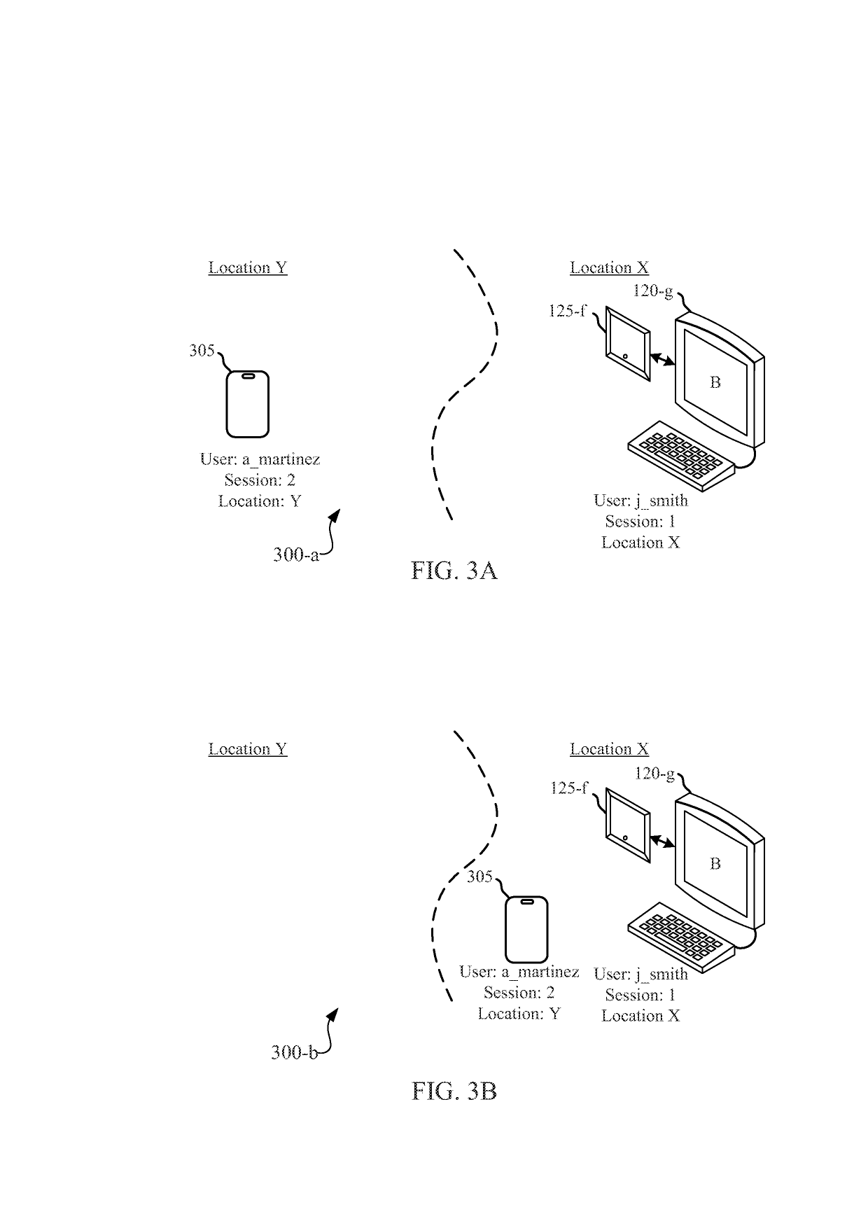

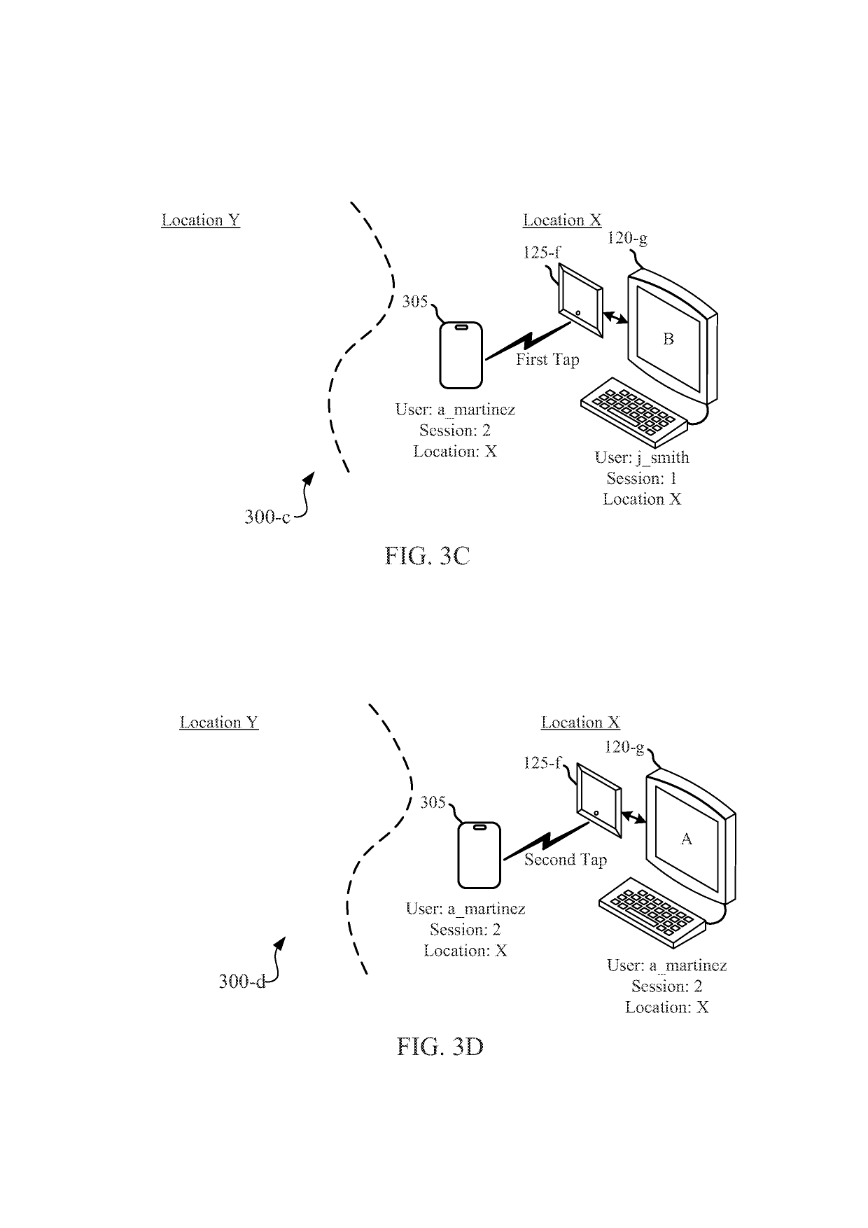

FIGS. 3A-3D illustrate an example system 300 in which a user having a valid virtual session may update his or her session using authentication data stored on an access card 205. The system 300 may be an example of one or more of the systems 100, 200 described above with reference to the previous Figures.

The user may create the virtual session by providing valid login credentials over a network to a central server computer system using a personal computer, mobile device, or any other suitable device for communicating over a network. The virtual session may allow the user to access protected resources offered by the central server computer system over the network. In one example, the user may be a medical practitioner at a health care facility, and the session may allow the user to access patient medical histories, records, and/or charts from a system provided over a network by the health care facility. In certain examples, the information provided to the user via the virtual session may be based at least partially on the location of the user. In the example of the healthcare facility, if the user is known to be in an examination room associated with a specific patient, the user may automatically receive medical records or test results for that patient on a device associated with the user session.

At FIG. 3A, the system 300 is shown in which an access card 205 associated with a user having the username of a_martinez is located at location Y. The access card 205 may store an access token identifying or authenticating the user. In this example, because the user is associated with virtual session 2 and location Y at a central server computer system, the access card 205 may also be associated with session 2 and location Y at the central server computer system. The user may interact with the central server computer system through the virtual session using, for example, a workstation terminal device at location Y or a portable terminals device (e.g., tablet computer, mobile phone, notebook, etc.). As described above, the central server computer system may selectively provide information and/or access to certain resources based on identity of the user, the identified virtual session, and/or the location associated with the virtual session. At location X, an access card reader 125-f may be communicatively coupled to terminal device 120-g, which may be communicatively coupled to the central server computer system. In the present example, the terminal device 120-g associated with the access card reader 125-f may be currently associated with user j_smith and session 1 at the central server computer system.

At FIG. 3B, the system 300 is shown as the location of the access card 205 associated with user a_martinez crosses over into location Y. When such a change of location occurs, it may be useful to associate the virtual session of user a_martinez with location Y, as it may be presumed that the location of the user is roughly the same as the location of the access card 205. However, as shown in FIG. 3B, the session for user a_martinez may remain associated with location Y until the information stored at the access card 205 is read by the access card reader 125-f (i.e., the access card 205 is “tapped”) at location X.

At FIG. 3C, the system 300 is shown after the access card 205 associated with a valid session has been “tapped” once to the access card reader 125-f to allow the access card reader 125-f to read the access token stored by the access card 205. As used in the present disclosure, the term “tap” refers to bringing an access card 205 or other physical credential into close enough physical proximity to an access card reader 125-f or other type of access device 125 that the access card reader 125-f or other access device 125 is able to communicate with the access card 205 or other physical credential to receive the access token stored by the access card 205 or other physical credential. Thus, the access card 205 may be tapped to access card reader 125-f without physically touching the access card reader 125-f.

In certain examples, if the access card reader 125-f receives a first tap from an access card 205 associated with a user having an invalid or expired session, or having no session at all, the user may be prompted to log in to a new session at a portable device associated with the user or at the terminal device 120-g associated with the access card reader 125-f. The location of the access card reader 125-f or the terminal device 120-g may be known in the system 300 to be location X.

After an access card 205 corresponding to a user with a valid session has been tapped to the reader 125-f, the access card reader 125-f may report the tap to the central server computer system via terminal device 120-g. Thus, when the access card 205 corresponding to user a_martinez is tapped to the access card reader 125-f, the central server computer system may be notified of the tap, recognize the access token as being associated with virtual session 2, and update the location associated with session 2 to location X. This operation may occur while user j_smith remains logged in to session 1 at the terminal device 120-g without disrupting session 1 on the terminal device 120-g or the activities of user j_smith. Alternatively, the access card reader 125-f may report the first tap of the access card 205 to the central server computer system through the terminal device 120-g without any user being logged into the terminal device 120-g.

The use of the access card reader 125-f allows user a_martinez to associate the new location with session 2 without actually logging in to terminal device 120-g associated with the access card reader 125-f. Returning to the example of a healthcare facility, this feature may prove useful to a user who logs into a virtual session with the central server computer system with a portable tablet computer. As the user moves from a first patient room to a second patient room, the user may tap his or her access card 205 once at an access card reader associated with a workstation terminal device 120-g in the second patient room, which may update the location associated with the user's session to the location of the second patient room and cause the central server computer system to automatically transmit data related to a patient in the second patient room to the user's tablet computer.

In the case of a user who accesses his or her session without a dedicated or portable terminal device, or a user who desires for some other reason to access his or her virtual session through the terminal device 120-g associated with the access card reader 125-f, the user may transfer his or her session to the terminal device 120-g associated with the access card reader 125-f by tapping the access card 205 to the access card reader 125-f for a second time within a predetermined period (e.g., 5 seconds) from the first tap.

FIG. 3D illustrates the system 300 after a second tap of the access card 205 is received by the access card reader 125-f within the predetermined amount of time from the first tap. The terminal device 120-g associated with the access card reader 125-f may transmit a notification or indication of the second tap to the central server computer system, which may then transfer the virtual session of user a_martinez to the terminal device 120-g associated with the access card reader 125-f. Thus, in the example of FIG. 3D, the terminal device 120-g associated with the access card reader 125-f may become associated with session 2 for user a_martinez at location X after the second tap of the access card 205.

As described above, other tapping sequences may be used. In certain examples, the session may be transferred to the terminal device 120-g associated with the access card reader 125-f after a first tap of the access card 205, and the location associated with the session may be updated to the location of the access card reader 125-f if the access card 205 is tapped twice within the predetermined amount of time.

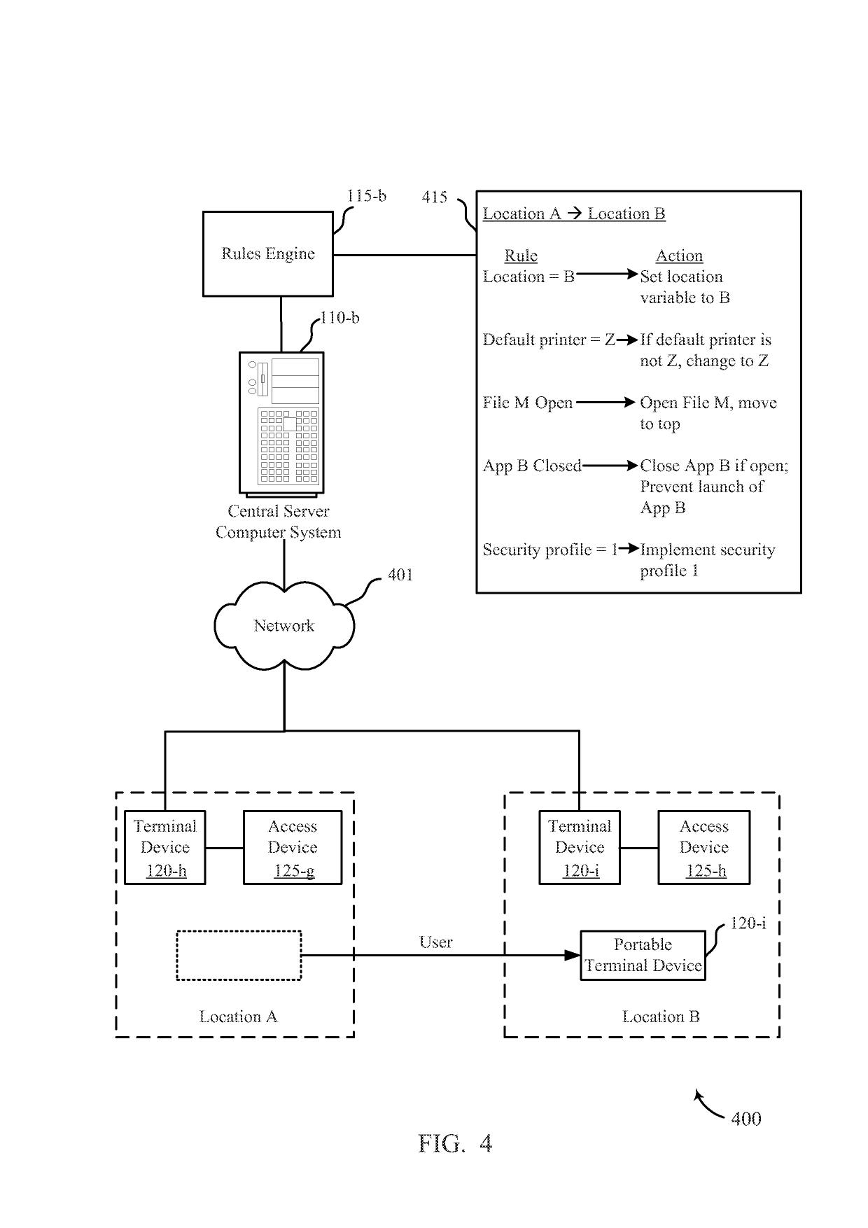

FIG. 4 is a block diagram illustrating an example of location-based rules that may be implemented upon associating a virtual session with a new location, as described above. The system 400 of the present example may include central server computer system 110-b, rules engine 115-b, network 401, terminal devices 120, and access devices 125. Each of these components may be in communication, directly or indirectly. The system 400 may be an example of one or more of the systems 100, 200, 300 described above with reference to the previous Figures. In the present example, the central server computer system 110-b may also function as a host device (e.g., host device 105 of FIG. 1) for virtual sessions.

In the example of FIG. 4, one or more terminal devices 120-h, 120-i may be disposed at each location tracked by the central server computer system 110-b to provide access to virtual sessions over network 401. Additionally, in certain examples, one or more access devices 125 may be disposed at each location to receive access tokens from users and initiate action based on the received access tokens. The location of each stationary terminal device 120 and/or access device 125 may be known or ascertainable by the central server computer system 110-b.

In the present example, a user may log on to portable terminal device (e.g., smartphone, tablet computer, laptop, etc.) 120-i at location A, and initiate a virtual session hosted by the central server computer system 110-b. The initiated session may be subject to certain location-based rules associated with location A, a type associated with the portable terminal device 120-h, and/or one or more attributes of the user. The user may then move with the portable terminal device 120-i to location B.

The central server computer system 110-b may determine that the user has moved from location A to location B based on the user providing an access token to access device 125-h at location B. In response to the determining that portable terminal device 120-i has now moved to location B, the central server computer system 110-b may retrieve a set of location-based rules 415 associated with the user at location B from the rules engine 115-b. The central server computer system 110-b may perform one or more actions associated with the rules with respect to the existing virtual session for the user to enforce or otherwise implement the set of location-based rules 415 applicable to the user at location B.

In the example of FIG. 4, a first location-based rule provides that a location variable associated with the existing session should be set to B. The action associated with the first rule includes setting the location variable to B for the existing session. A second location-based rule may provide that a default printer for the session is Z. The action associated with the second rule may include configuring the session such that the default printer is Z. A third location-based rule may provide that file M is to be open at location B. The actions associated with the third rule may include opening file M and moving a window containing file M to the tope of a user interface for the virtual session. A fourth location-based rule may provide that application B is to be closed at location B. The actions associated with the fourth rule may include closing application B if it is open in the existing session, and taking steps to preventing the future launch of application B at location B. A fifth location-based rule may provide that a security profile for the virtual session is to be set to level 1 while the user is at location B. The action associated with the fifth rule may include adjusting the configurations and settings of the session to implement a predefined level 1 security profile.

In the present example, following implementation of the rules associated with location B, the user may continue to access the updated virtual session at the portable terminal device 120-i at location B.

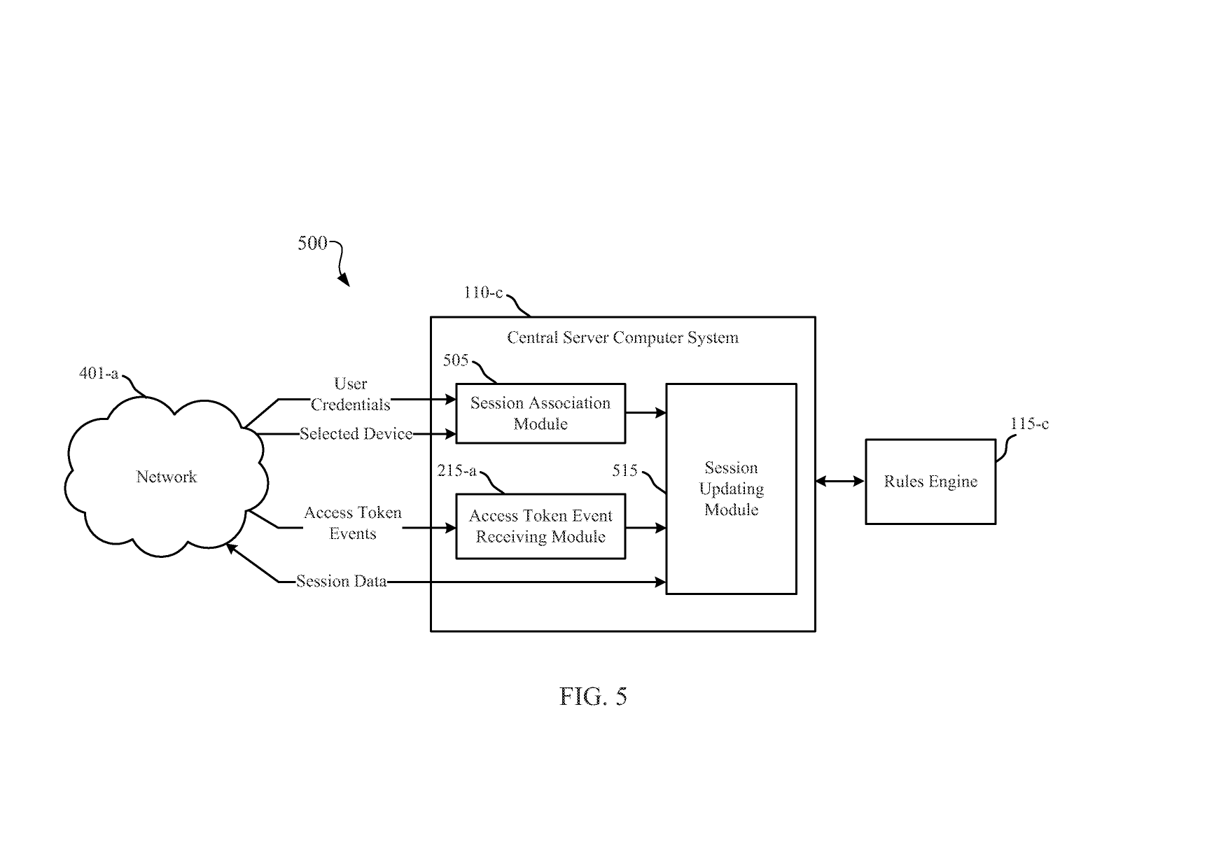

FIG. 5 is a block diagram of an illustrative system 500 including a central server computer system 110-c, a network 401-a, and a rules engine 115-c. The system 500 may be an example of one or more of the systems described above with reference to the previous Figures. The central server computer system 110-b of the present example may be communicatively coupled with the network 401-a and the rules engine 115-c.

The central server computer system 110-c of the present example may include a session association module 505, an access token event receiving module 215-a, and a session updating module 515. The session association module 505 may associate virtual sessions implemented at the central server computer system 110-c or a host device with users and locations. In the case of a new virtual session, the session association module 505 may receive user credentials and an identification of a selected terminal device over the network 401-a from a user of the selected terminal device. The session association module 505 may validate the user credentials and instantiate a new virtual session for the user of the selected terminal device. A location may be associated with the new session. The location may be a default location, a location determined based on the selected terminal device, and/or a location entered by the user during the creation of the new session. A record of the instantiated virtual session, including information about the location and the selected terminal device, may be stored in a data store associated with the central server computer system 110-c.

If the user provides an access token (e.g., from access card 205 of FIG. 2 and FIGS. 3A-3D) to an access device (e.g., access device 125 of FIGS. 1-4) affiliated with a terminal device (e.g., terminal device 120 of FIGS. 1-4), the access token event receiving module 215-a may receive an access token event from the terminal device indicating receipt of the access token at the access device. If the user is logged in and access token is provided for the first time within a predetermined amount of time, then the session updating module 515 may update the location associated with the virtual session of the user to a known location of the access device or a known location of the terminal device associated with the access device. The session updating module 515 may also update the virtual session provided to the terminal device currently associated with the virtual session based on at least one location-based rule associated with the updated location. If the user is logged in and the access token is provided to the access device twice within the predetermined amount of time, then the session updating module 515 may transfer or duplicate the user's virtual session to the terminal device associated with the access device. In other examples, the session updating module 515 may update the location of the virtual session, apply the at least one location-based rule to the virtual session, and/or transfer the virtual session to the terminal device associated with the access device based on a different sequence.

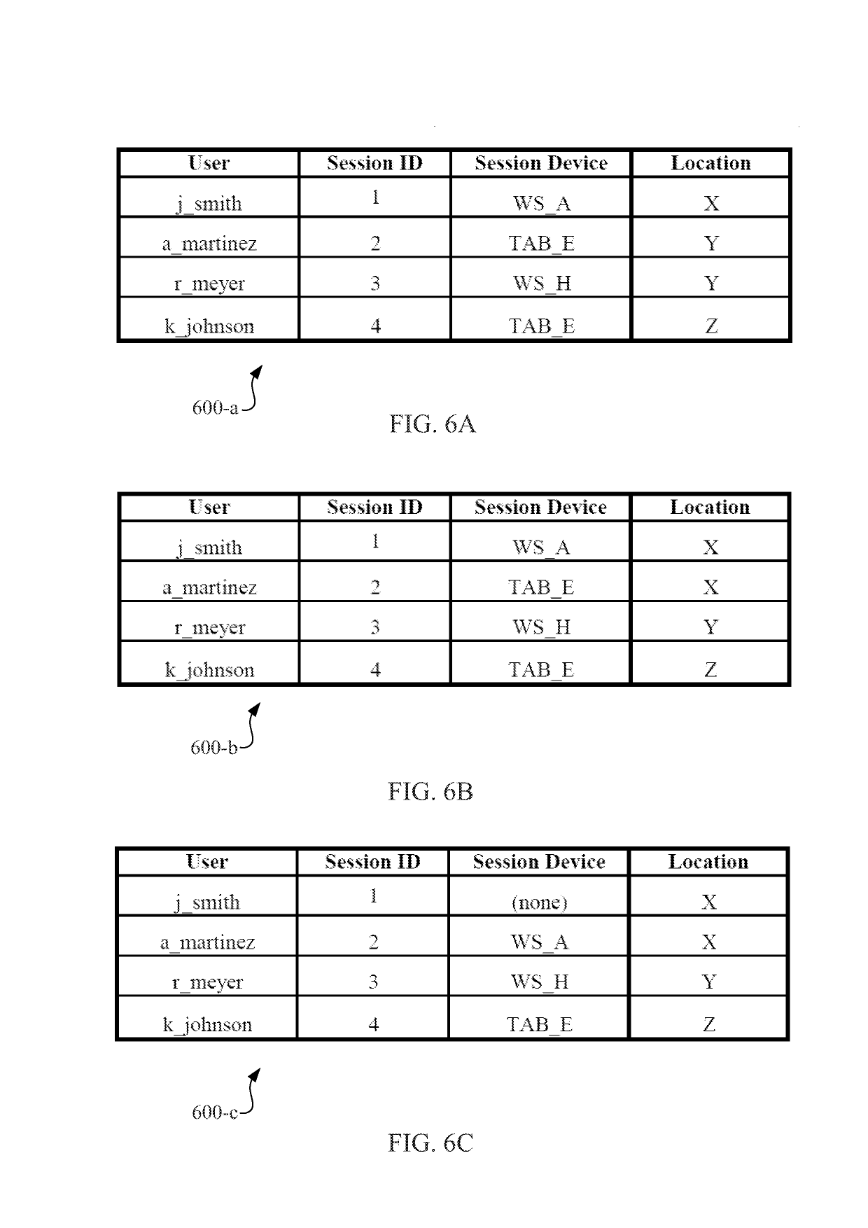

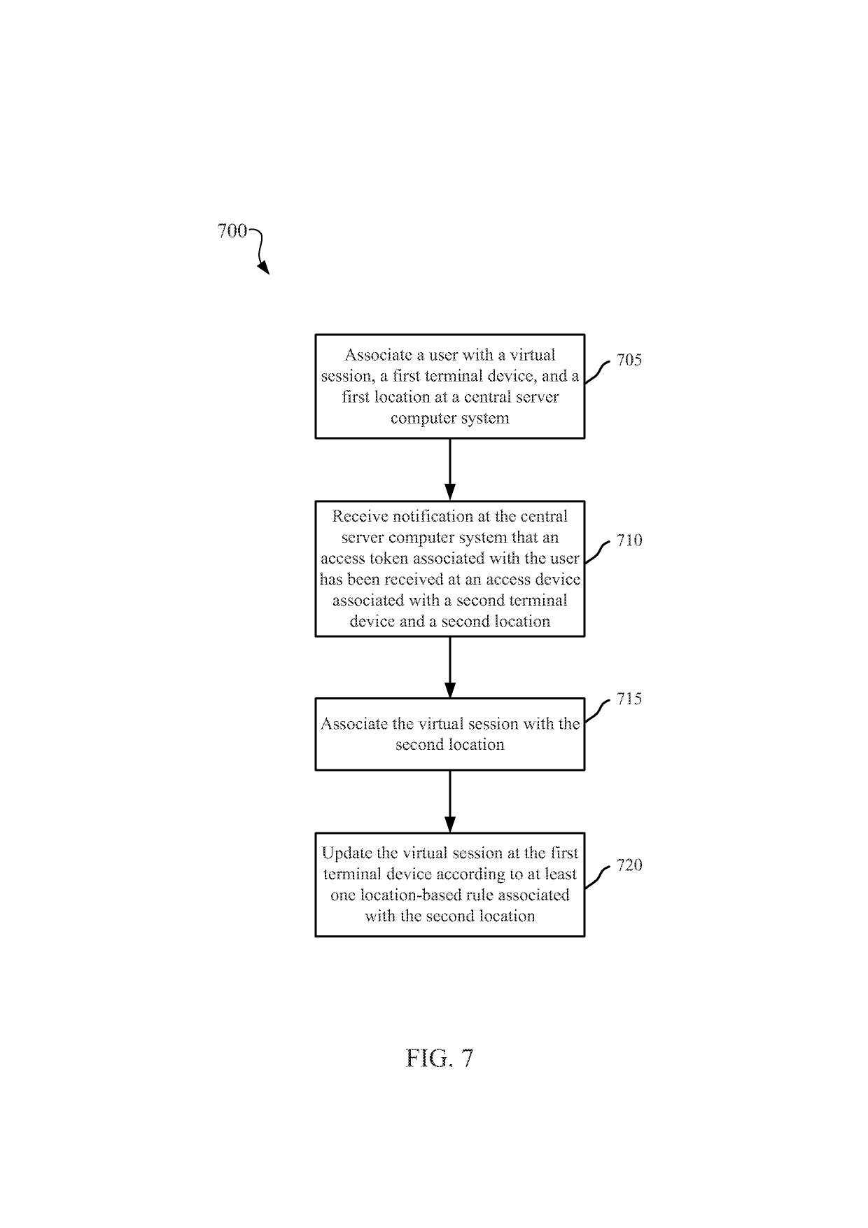

FIGS. 6A-6C show examples of a session information table 600 which may be used by a central server computer system and a rules engine (e.g., central server computer system 110 and rules engine 115 of FIGS. 1-5) to implement and maintain virtual sessions for different users. FIG. 6A illustrates the session information table 600 at a first point in time, FIG. 6B illustrates the information table 600 at a second point in time, and FIG. 6C illustrates the information table 600 at a third point in time. In one example, FIG. 6A illustrates the content of the table 600 at a point in time corresponding to the example of FIGS. 3A and 3B, FIG. 6B illustrates the content of the table 600 at a point in time corresponding to the example of FIG. 3C, and FIG. 6C illustrates the content of the table 600 at a point in time corresponding to the example of FIG. 3D.

The table 600 may associate individual users, represented by usernames, with session ID numbers, user devices, and locations. As shown in FIG. 6A, the user with the user name a_martinez may originally be associated with session 2 at table computer terminal device TAB_E at location Y. As shown in FIG. 6B, user a_martinez may update the location associated with his or her session to location X in the table 600 by tapping an access card (e.g., access card 205 of FIGS. 2 and 3A-3D) to an access card reader (e.g., access device 125 of FIGS. 1-4) associated with location X while logged in. As shown in FIG. 6C, user a_martinez may transfer his or her session from tablet computer terminal device TAB_E to workstation terminal device WS-A by tapping his or her access card to the same access card reader a second time within a predetermined amount of time.

FIG. 7 is a flowchart diagram of an example method 700 of managing at least one centrally hosted virtual session, according to the principles described above. The method 700 may be performed, for example, by one or more of the central server computer systems 110 described above with reference to the previous Figures.

At block 705, a user may be associated with a virtual session, a first terminal device, and a first location at the central server computer system. At block 710, a notification may be received at the central server computer system that an access token associated with the user has been received at an access device associated with a second terminal device and a second location. At block 715, the virtual session may be associated with the second location in response to the notification. At block 720, the virtual session may be updated at the first terminal device according to at least one location-based rule associated with the second location.

In certain examples, updating the virtual session at the first terminal device may include changing at least one access permission associated with the virtual session based on the second location, changing an execution status (e.g., whether the application is running or closed in the virtual session) of at least one application of the virtual session based on the second location, changing a display status (e.g., displayed or hidden) of one or more elements (e.g., windows, dialog boxes, images, menus, toolbars, etc.) of a user interface of the virtual session based on the second location, or opening or closing a file in the virtual session based on the second location.

In certain examples, the notification of the receipt of the access token at the access device may be processed and transmitted to the central server computer system from the second terminal device associated with the access device without affecting a display of a second virtual session associated with a second user at the second terminal device.

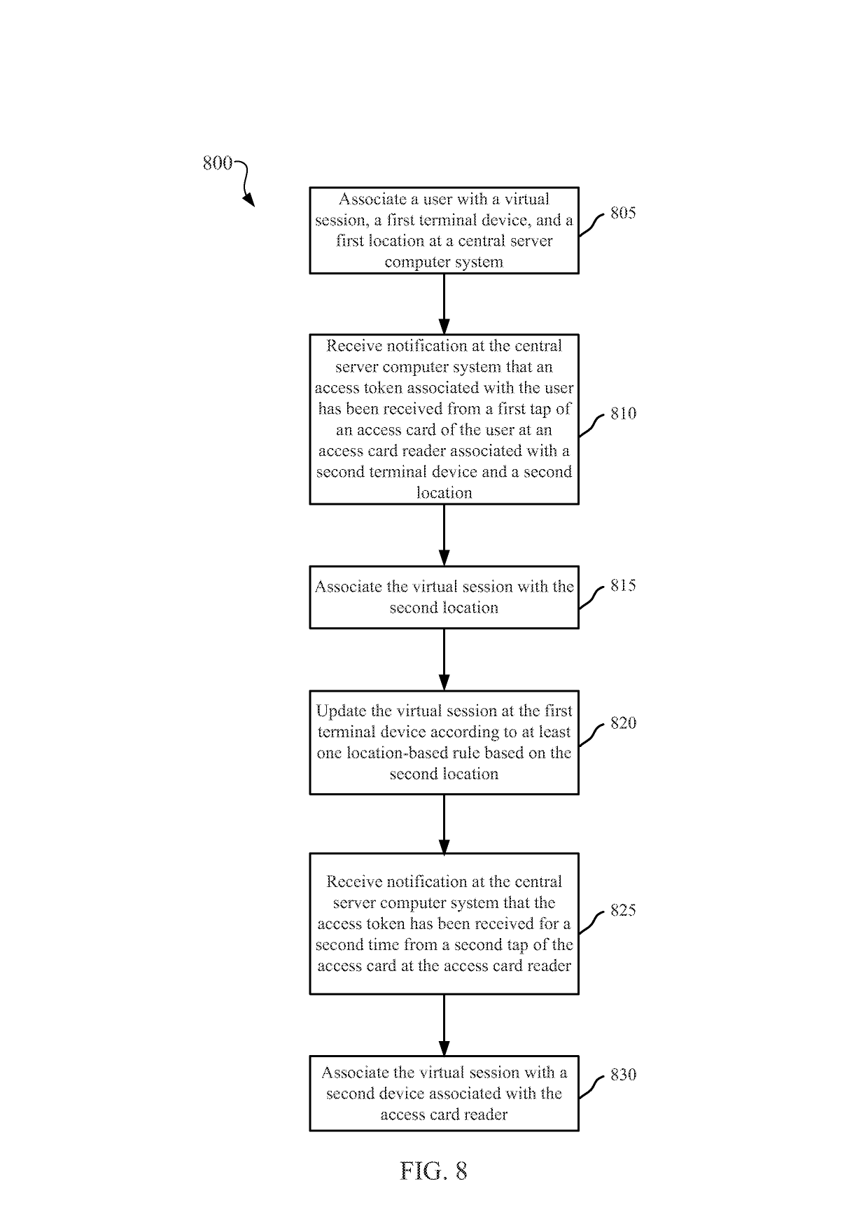

FIG. 8 is a flowchart diagram of an example method 800 of managing at least one centrally hosted virtual session, according to the principles described above. The method 800 may be performed, for example, by one or more of the central server computer systems 110 described above with reference to the previous Figures. The method 800 may be an example of the method 700 of FIG. 7.

At block 805, a user may be associated with a virtual session, a first terminal device, and a first location at the central server computer system. At block 810, the central server computer system may receive a notification that an access token associated with the user has been received from a first tap of an access card of the user at an access card reader associated with a second terminal device and a second location. At block 815, the virtual session of the user may be associated with the second location at the central server computer system. At block 820, the virtual session may be updated at the first terminal device according to at least one location-based rule based on the second location. At block 825, a notification may be received at the central server computer system that the access token has been received for a second time from a second tap of the access card at the access card reader associated with the second terminal device at the second location. At block 830, the virtual session of the user may be associated with the second device based on the notification of the receipt of the access token for the second time.

In certain examples, the notification of the receipt of the access token for the second time may indicate that the access token has been received at the access token device for the second time in a predetermined amount of time. In certain examples, associating the virtual session with the second device may include communicating with the second terminal device to display a user interface of the virtual session on the second terminal device. The user interface may be duplicated or transferred to the second terminal device.

In certain examples, a second user associated with a second session may be automatically logged out of the second terminal in response to the association of the virtual session of the first user with the second terminal device.

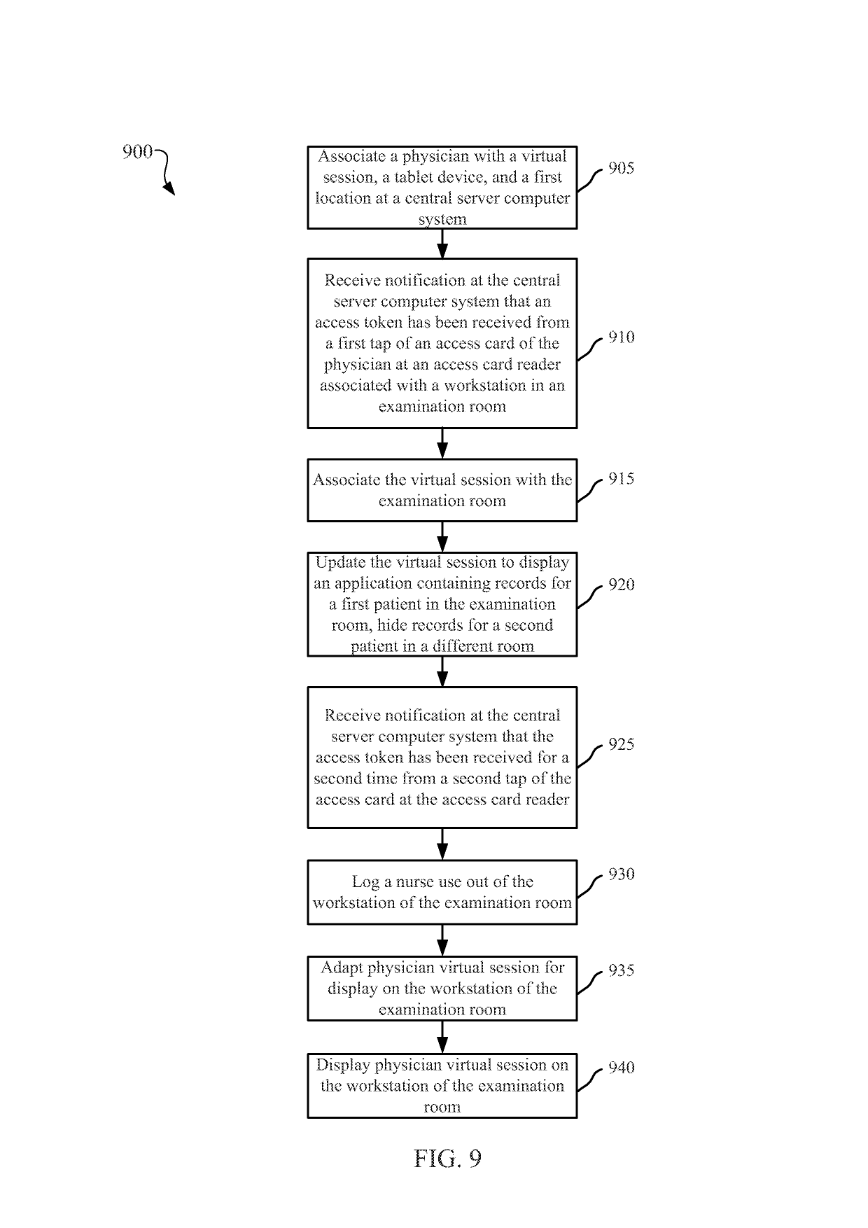

FIG. 9 is a flowchart diagram of an example method 900 of managing at least one centrally hosted virtual session in the context of a medical facility, according to the principles described above. The method 900 may be performed, for example, by one or more of the central server computer systems 110 described above with reference to the previous Figures. The method 900 may be an example of the method 700 of FIG. 7 or the method 800 of FIG. 8.

At block 905, a physician user may be associated with a virtual session, a tablet terminal device, and a first location at the central server computer system. At block 910, the central server computer system may receive a notification that an access token has been received from a first tap of an access card of the physician at an access card reader associated with a workstation terminal device in an examination room. A nurse may be logged in to a separate virtual session at the workstation terminal device when the physician taps his or her access card, and the tap of the physician's access card may not interrupt the virtual session of the nurse.

At block 915, the location associated with the virtual session of the physician may be updated to the examination room containing the workstation terminal device and the access device. At block 920, the virtual session of the physician may be updated to display an application containing records for a first patient associated with the current examination room on the tablet terminal device of the physician and to hide records for a second patient associated with a different examination room on the tablet terminal device of the physician.

At block 925, a notification may be received at the central server computer system that the access token has been received for a second time from a second tap of the physician's access card at the access card reader. In response to this notification of the second tap, the nurse may be logged out of the workstation terminal device of the examination room at block 930, the physician's virtual session may be adapted for display on the workstation terminal device of the examination room at block 935, and the physician's virtual session may be displayed on the workstation terminal device of the examination room at block 940.

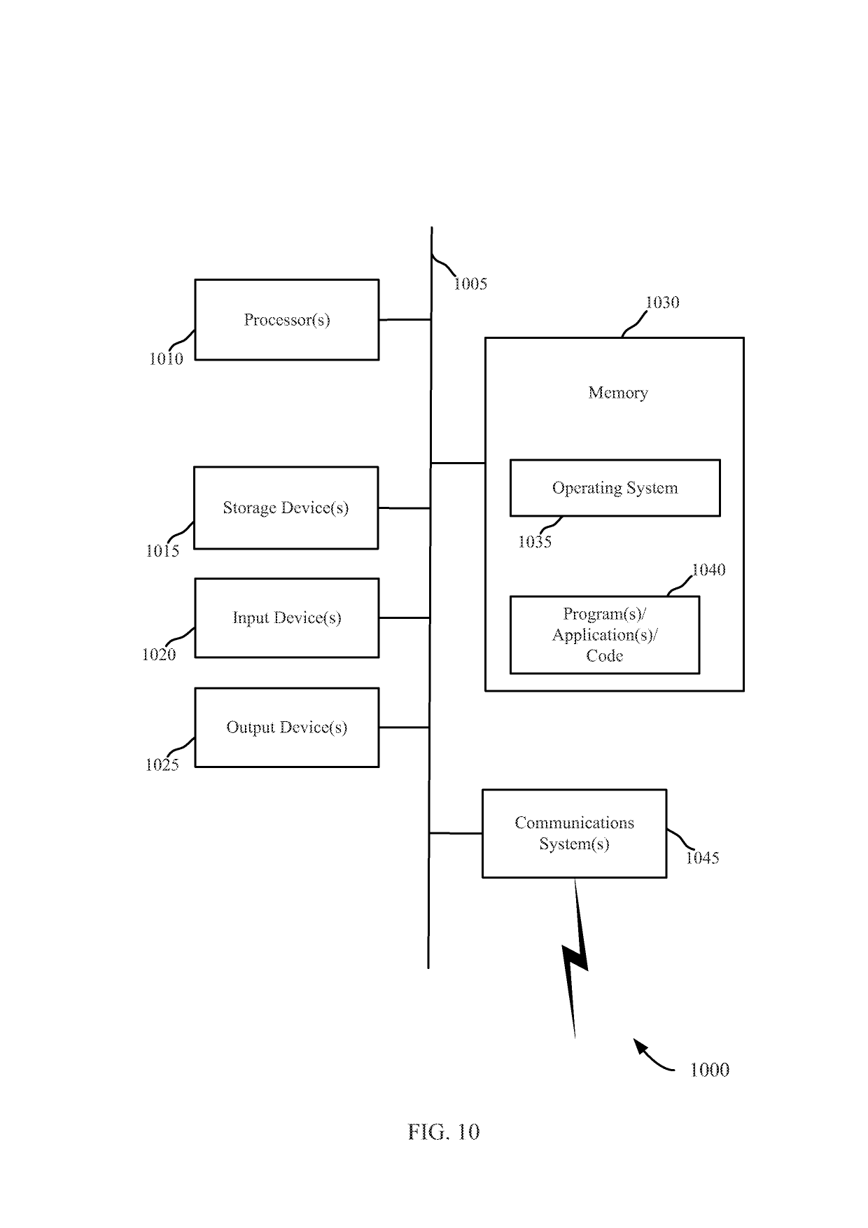

A device structure 1000 that may be implement one or more of the host device 105, central server computer system 110, terminal device 120, or access device 125 described above with reference to the previous Figures, or other computing devices described herein, is illustrated with the schematic diagram of FIG. 10. This drawing broadly illustrates how individual system elements of each of the aforementioned devices may be implemented, whether in a separated or more integrated manner. The exemplary structure is shown comprised of hardware elements that are electrically coupled via bus 1005, including processor(s) 1010 (which may further comprise a digital signal processor (DSP) or special-purpose processor), storage device(s) 1015, input device(s) 1020, and output device(s) 1025. The storage device(s) 1015 may be a machine-readable storage media reader connected to any machine-readable storage medium, the combination comprehensively representing remote, local, fixed, or removable storage devices or storage media for temporarily or more permanently containing computer-readable information. The communications systems interface 1045 may interface to a wired, wireless, or other type of interfacing connection that permits data to be exchanged with other devices. The communications system(s) 1045 may permit data to be exchanged with a network.

The structure 1000 may also include additional software elements, shown as being currently located within working memory 1030, including an operating system 1035 and other code 1040, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

The components set forth in the foregoing Figures may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of managing at least one centrally hosted virtual session, the method comprising:
associating a user with a virtual session, a first terminal device, and a first location at a central server computer system;
receiving a notification at the central server computer system that an access token associated with the user has been received at an access device associated with a second terminal device and a second location;
associating the virtual session with the second location in response to the notification; and
updating the virtual session at the first terminal device according to at least one location-based rule associated with the second location.

2. The method of claim 1, further comprising:
receiving a notification at the central server computer system that the access token has been received for a second time at the access device; and
associating the virtual session with the second terminal device based on the notification of access device receiving the access token for the second time.

3. The method of claim 2, further comprising:
communicating with the second terminal device to display a user interface of the virtual session on the second terminal device.

4. The method of claim 3, further comprising:
adapting the user interface for display on the second terminal device in response to the association of the virtual session with the second terminal device.

5. The method of claim 2, further comprising:
logging a second user associated with a second session out of the second terminal device in response to the association of the virtual session with the second terminal device.

6. The method of claim 1, wherein the updating the virtual session at the first terminal device comprises:
changing at least one access permission associated with the virtual session based on the second location.

7. The method of claim 1, wherein the updating the virtual session at the first terminal device comprises:
changing an execution status of at least one application of the virtual session based on the second location.

8. The method of claim 1, wherein the updating the virtual session at the first terminal device comprises:
changing a display status of one or more elements of a user interface of the virtual session based on the second location.

9. The method of claim 1, wherein the updating the virtual session at the first terminal device comprises one or more of:
opening or closing a file in the virtual session based on the second location.

10. The method of claim 1, wherein the notification is received from the second terminal device without affecting a display of a second session associated with a second user at the second terminal device.

11. A central server computer system for managing at least one virtual session, the central server computer system comprising:
a session association module configured to associate a user with a virtual session, a first terminal device, and a first location at a central server computer system;
an access token event receiving module configured to receive a notification that an access token associated with the user has been received at an access device associated with a second terminal device and a second location, wherein the session association module is further configured to associate the virtual session with the second location in response to the notification; and
a session updating module configured to update the virtual session at the first terminal device according to at least one location-based rule associated with the second location.

12. The central server computer system of claim 11, wherein:
the access token event receiving module is further configured to receive a notification at the central server computer system that the access token has been received for a second time at the access device; and
the session association module is further configured to associate the virtual session with the second terminal device based on the notification of access device receiving the access token for the second time.

13. The central server computer system of claim 12, wherein the session association module is further configured to:
communicate with the second terminal device to display a user interface of the virtual session on the second terminal device.

14. The central server computer system of claim 13, further comprising:
adapting the user interface for display on the second terminal device in response to the association of the virtual session with the second terminal device.

15. The central server computer system of claim 12, further comprising:
logging a second user associated with a second session out of the second terminal device in response to the association of the virtual session with the second terminal device.

16. The central server computer system of claim 11, wherein the updating the virtual session at the first terminal device comprises:
changing at least one access permission associated with the virtual session based on the second location.

17. The central server computer system of claim 11, wherein the updating the virtual session at the first terminal device comprises:
changing an execution status of at least one application of the virtual session based on the second location.

18. The central server computer system of claim 11, wherein the updating the virtual session at the first terminal device comprises:
changing a display status of one or more elements of a user interface of the virtual session.

19. The central server computer system of claim 11, wherein the updating the virtual session at the first terminal device comprises one or more of:
opening or closing a file in the virtual session based on the second location.

20. A computer program product, comprising:
a tangible computer readable device comprising computer-readable instructions stored thereon, the computer-readable instructions configured to cause at least one processor, upon execution of the computer-readable instructions, to:
associate a user with a virtual session, a first terminal device, and a first location at a central server computer system;
receive a notification that an access token associated with the user has been received at an access device associated with a second terminal device and a second location;
associate the virtual session with the second location in response to the notification; and
update the virtual session at the first terminal device according to at least one location-based rule associated with the second location.
